(19) United States
(12) Patent Application Publication
(10) Pub. No.: US 2001/0049629 A1
(43) Pub. Date: Dec. 6, 2001

(54) Package location system

(76) Inventor: Jeffrey R. Freeman, Attleboro, MA (US)

Correspondence Address: WEINGARTEN, SCHURGIN, GAGNEBIN, & HAYES, LLP, TEN POST OFFICE SQUARE, BOSTON, MA, 02109, US

(21) Appl. No.: 09/757,825

(22) Filed: Jan. 10, 2001

Related U.S. Application Data
(60) Provisional application No. 60/175,535, filed on Jan. 11, 2000.

(51) Int. Cl. G06F 17/60; G06G 1/14

(52) U.S. Cl. 705/23; 705/1; 705/22; 705/28

(57) ABSTRACT

A system is provided for locating an intended package, product or other item that may be located in an area where a number of such packages may be located, such as a warehouse, receiving area or the like. The novel system allows personnel to quickly identify a particular package or package location from among other packages in the area. The system comprises a wireless transmitter which is operative to transmit coded signals each associated with a respective package to be located. A receiving device is disposed on or near each particular package being sought. The receiving device upon receipt of an interrogating signal from the transmitter and recognition of a unique code indicates its presence by an audible and/or visible response.

### CROSS REFERENCE TO RELATED APPLICATIONS

The applicant claims the benefit under Title 35, USC §119(e) of U.S. provisional application serial No. 60/175,535 filed Jan. 11, 2000, the disclosure of which is incorporated herein by reference.

### BACKGROUND OF THE INVENTION

It is often difficult to locate a particular package, carton or other item among many items stored on a loading dock or at a warehouse or other storage facility. Locating an individual package or other item is often difficult and time consuming where the package may be obscured at the bottom of a stack of cartons or the back of other cartons. For example, in the receiving area of a retail facility, especially where the size of the receiving area is restricted, a large volume of packages, skids, totes and other items is received on a daily basis and accumulate in the receiving area and often in random fashion. For efficient distribution the items must be identified, segregated and prioritized. Systems have been proposed for locating items by means of tags which can be interrogated by a wireless signal but such systems have been complex and/or uneconomical.

As an example of location problems, in a typical large discount store the receiving area may contain about 3,500 cartons in any given day. A typical chain drugstore may receive about 300 totes per day. Locating particular cartons or totes is time consuming and difficult especially in receiving areas which are of limited size.

As another example, shipping companies often arrange shipments on skids which are located at a distribution center for loading onto trucks, other vehicles or containers for shipment to various destinations. Finding particular skids intended for particular destinations is often difficult because of the number of skids present in a given location. This problem of finding “trapped freight” wastes a great deal of time in assembling shipments.

### BRIEF SUMMARY OF THE INVENTION

In accordance with the invention, a system is provided for locating an intended package, product or other item that may be located in an area where a number of such packages may be located, such as a warehouse, receiving dock or the like. The novel system allows personnel to quickly identify a particular package or package location from among other packages in the area. The system comprises a wireless transmitter which operates preferably at a radio frequency and which is operative to transmit address codes associated with respective packages to be located. A receiving device is disposed in, on or near each package being sought. The receiving device upon receipt of an interrogating signal from the transmitter and recognition of a unique address code indicates its presence by an audible and/or visible response.

The system is particularly useful in handling an inventory of packages, skids, totes and other items in the manufacturing, retail and distribution industries. The present system permits the location of individual items and avoids the time consuming and physical tasks of handling and looking through or moving stacks of packages and other items to identify intended ones.

The receiving device is preferably in the form of a small tag which can be placed inside a package or which can be affixed to the package. The tag can be programmable by the shipper or vendor to provide a unique address code which is communicated to the recipient. The recipient can interrogate packages in a receiving area by transmission of intended address codes to produce sensible responses by the identified packages.

### BRIEF DESCRIPTION OF THE SEVERAL VIEWS OF THE DRAWING

The invention will be more fully understood from the following detailed description in conjunction with the accompanying drawings, in which:

FIG. 1 is a diagrammatic representation of a system according to the invention in which each item to be located is tagged;

FIG. 2 is a block diagram of a receiver device;

FIG. 3 is a block diagram of an embodiment of a system in accordance with the invention in which bin areas of an inventory rack are tagged;

FIG. 4 is a block diagram of a further embodiment in which the system is employed with computer terminals operating via a data link;

FIG. 5 is a flow diagram of system operation;

FIG. 6 is a block diagram of a programming apparatus; and

FIG. 7 is a block diagram of still another embodiment utilizing wireless repeaters.

### DETAILED DESCRIPTION OF THE INVENTION

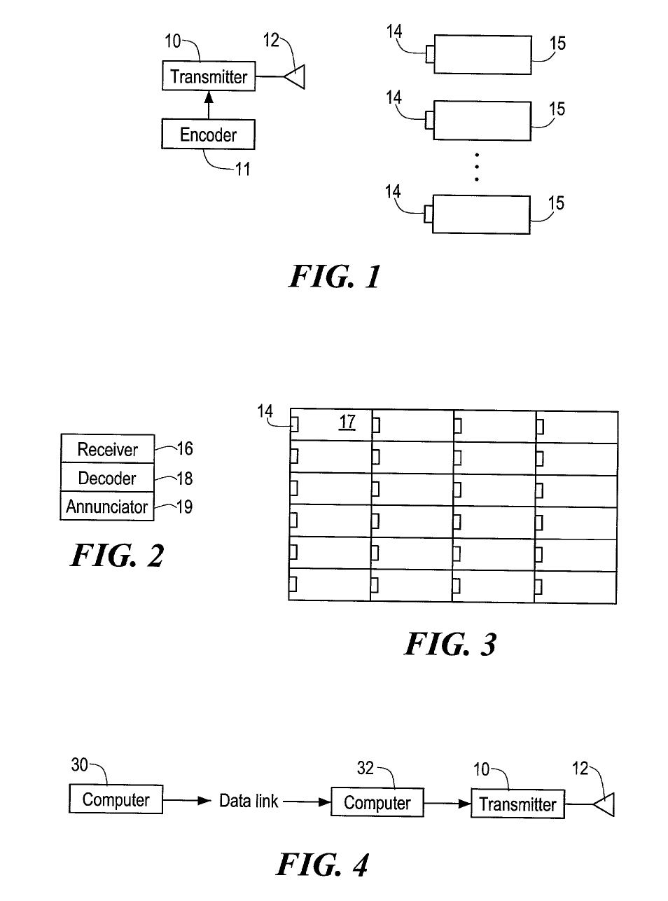

The system is shown diagrammaticaly in FIG. 1. A transmitter 10 includes an encoder 11 which is programmable to provide a plurality of individual addresses each unique to a respective receiver device. The transmitter emits via a suitable antenna 12 a radio frequency (RF) signal coded with the respective address for identification of a corresponding package or other item. A receiver device 14 is attached to respective items 15 to be identified or is placed in the item such as a box or tote. As seen in FIG. 2, each of the devices includes an RF receiver 16, a decoder 18 which is responsive to only the particular address code intended for that device, and an annunciator 19, which preferably is an audible and/or visual indicator activated in response to a signal from the receiver 16 upon detection of the unique code.

The encoder provides respective codes each of which is unique to a corresponding item to be identified. The coded signal can be provided by any well known modulation or signal coding technique. This coded signal is modulated onto a carrier signal for transmission and can be of analog, pulsed or digital signal format.

The receiver device 14 is preferably embodied in a small tag which can be affixed to an item to be located. Alternatively, the tag can be used with skids, totes or other collections of items to locate the collection. The tag can also be used on a bin or other definable area of items to be located, as shown in FIG. 3. Referring to FIG. 3, the transmitter 10 communicates with a plurality of tags 14, each disposed at a respective bin location 17. Upon receipt of a recognized address code of the transmitted signal, the appropriate tag 14 causes an output indication of bin location.

The tags can be made very cheaply by techniques which themselves are known in the art of manufacturing electronic article surveillance tags or smart cards. The tag circuits can be housed in a small plastic or other suitable enclosure which can be placed inside a package or other item, or removably attached to packages or items such as by an adhesive.

The tags can be programmed by a shipper or vendor with respective address codes for the items to be shipped to a particular recipient. The shipper communicates the tag address codes to the recipient by any convenient means such as e-mail, direct data link or any other communication technique. The recipient upon receipt of the address code list can scroll through the list and produce a series of commands to be sent by the transmitter for interrogation of the packages in a receiving area. The tags responsive to their respective address codes provide a sensible indication of package presence such as by an audible and/or visible annunciation. In an alternative embodiment the transmitter can be programmed over a data link by the shipper or vendor as described below.

The tags may be programmed locally by the recipient by use of the transmitter or other programming apparatus using address codes previously provided to the recipient.

The tags may be re-programmable so that they can be removed from the received packages by the recipient and sent back to the shipper for reuse. The tags may also be programmed with other data such as the identification of the vendor, identification of the recipient and other data that may be useful for inventory and shipping purposes. The identification of the vendor and recipient is particularly useful as part of a recycling program in which the recipient sends used tags back to the vendor or other designated party for credit.

The transmitter may be located in the general vicinity of the tags, such as in a warehouse or shipping facility. Or the transmitter may be located remotely from the item location and with a communication link provided between the transmitter and tags. The communication link can include the Internet, wired, wireless or other communication links. For use with the Internet or other computer networks, an interrogation command can be sent by a requesting party over the Internet to a receiving destination at which point an RF coded signal is transmitted in response to the received command to trigger a response by the tagged item or area to be located.

Referring to FIG. 4, there is shown a computer 30 coupled via a data link to a computer 32 which provides command signals to transmitter 10. Intended package addresses are provided by the computer 30 and conveyed over the data link to computer 32. The computer 32 provides appropriate command signals to the transmitter 10 for transmission of a coded RF signal to the receiver tags. The data link can include any wired or wireless path or the Internet or other computer network.

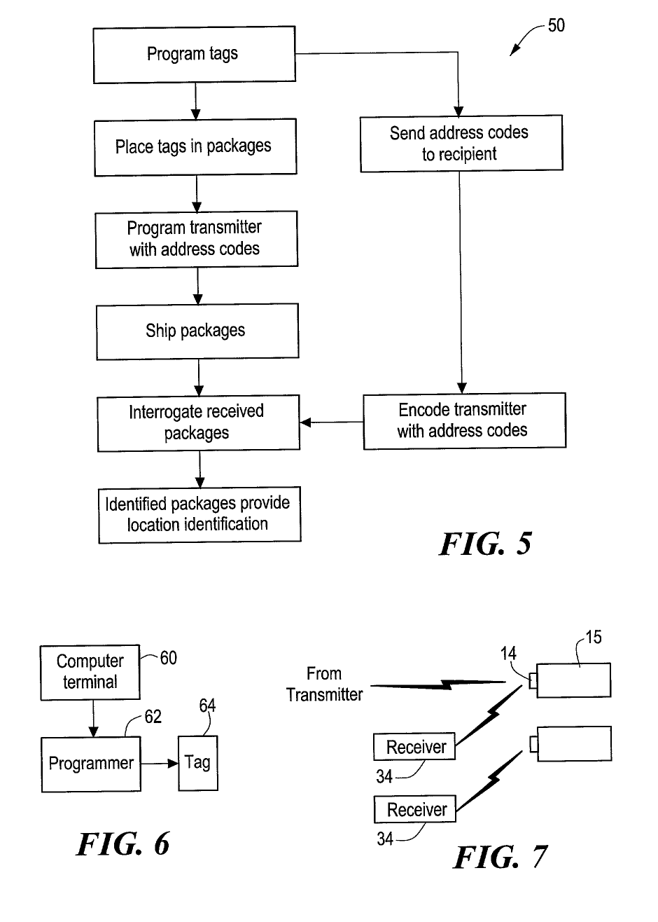

System operation is shown diagrammatically in FIG. 5. A shipper or vendor programs tags associated with respective packages with address codes unique to each package. The programming is accomplished by use of apparatus as shown in FIG. 6 which can typically include a computer terminal 60 and programmer unit 62 which provides programming signals to a tag 64. The tag typically contains a memory device to store the address code. After coding the tags with respective address codes, the tags are placed in respective packages or otherwise affixed or associated with those packages.

The shipper or vendor conveys the address codes to the recipient's location to program the transmitter with those address codes. This is typically accomplished as shown in FIG. 4 by transmission of address codes from the shipper's computer over a data link to the recipient's computer which is coupled to the transmitter.

The packages with the associated coded tags are then shipped to an intended recipient. The recipient sequentially interrogates the received packages with coded signals from the transmitter, and the identified packages provide sensible indications of their location.

In an alternative implementation, the shipper communicates the address codes to the recipient and the recipient encodes the transmitter with address codes as shown in the alternative path 50 of FIG. 5.

In some instances, a user may not know the address or identification code of an item being sought. In this instance, the system can include a scanning or search facility which can be employed to find the correct address of the tag being sought. If the address is found, an interrogating signal is sent to trigger a response by the receiving tag to denote the presence or location of the tag and the item or area to which it is associated.

Another embodiment is shown in FIG. 7 in which coded signals from transmitter 10 are received by tags 14 affixed to or placed in respective packages 15. The tags are operative upon detection of their respective codes to radiate a signal to one or more receivers 34. The receivers would typically be located in respective areas to locate packages associated with those areas. Upon receipt of a signal from a tag, a receiver 34 would trigger a sensible audible or visual indication to denote the location.

Various modifications and alternative implementations may occur to those versed in the art without departing from the spirit and true scope of the invention. For example, the transmitter can provide wireless signals of any frequency or form such as radio, infrared, ultrasonic, etc. The tags can be implemented in various circuit forms suitable for the signals and frequencies involved. The tags can also be employed with packages of any form which can include boxes and cartons of any type, skids, totes and other containers for items. The packages can also be employed at storage locations such as on bins, shelves and the like. Accordingly, the invention is not to be limited by what has been particularly shown and described, but is to embrace the full scope of the appended claims.

1. A system for locating a package from among other packages in the vicinity, comprising:
a transmitter operative to transmit wireless signals having address codes representative of the identity of respective packages to be located;
apparatus for providing the address codes to the transmitter;
a receiving device associated with each package and operative to receive the wireless signals from the transmitter and in response to a unique address code to provide an identifying signal; and
an annunciator operative in response to the identifying signal to provide a sensible indication of package location.

2. The system of claim 1 wherein the apparatus for providing the address codes for the transmitter is at a location remote from a recipient's location and wherein the address codes are provided over a data link between the vendor location and the recipient's location.

3. The system of claim 1 wherein the apparatus for providing the address codes for the transmitter is at the recipient's location.

4. The system of claim 1 wherein the transmitter includes a programmable encoder for providing a series of codes which are sequentially transmitted with the wireless signal.

5. The system of claim 4 wherein the receiving device is a tag which can be affixed to an item to be located.

6. The system of claim 1 wherein the indicator provides an audible indication.

7. The system of claim 1 wherein the indicator provides a visual indication.

8. The system of claim 1 wherein the indicator provides an audible and visual indication.

9. The system of claim 1 wherein the apparatus for providing the address codes is at a vendor location and wherein the address codes are provided over a data link between the vendor location and the recipient's location.

10. The system of claim 1 wherein the apparatus for providing the address codes to the transmitter also provides other data.

11. The system of claim 10 wherein the other data includes vendor identification and recipient identification.

12. A system for identifying a particular item location from among other items in the vicinity, the system comprising:
a wireless transmitter operative to transmit a wireless signal having a unique coded representation of the identity of each respective item to be located;
a receiving device disposable at an item location and having a receiver circuit for receiving the wireless signal from the transmitter and a decoder operative in response to a unique received code to provide an identifying signal; and
an annunciator operative in response to the identifying signal to provide a sensible indication to allow a user to identify the item location.

13. The system of claim 12 wherein the tag is removably attachable to the item.

14. The system of claim 12 wherein the receiving device is a tag which can be placed in an item to be located.

15. The system of claim 12 wherein the receiving device is operative to radiate a signal to a remote indicator.
